(19) United States
(12) Patent Application Publication
(10) Pub. No.: US 2008/0043766 A1
(43) Pub. Date: Feb. 21, 2008

(54) Method and System of Message Prioritization in a Control System

(75) Inventors: Ryan A. Bryngelson, Marshalltown, IA (US); Damon J. Ellender, Tomball, TX (US); Scott A. Griffin, Colo, IA (US)

Correspondence Address: CONLEY ROSE, P.C.;David A. Rose, P. O. BOX 3267, HOUSTON, TX, 77253-3267, US

(73) Assignee: DANIEL MEASUREMENT AND CONTROL, INC., Houston, TX (US)

(21) Appl. No.: 11/465,939

(22) Filed: Aug. 21, 2006

(51) Int. Cl. H04L 12/56

(52) U.S. Cl. 370/412

(57) ABSTRACT

A method and related system of message prioritization in a control system. At least some of the illustrative embodiments are methods comprising receiving a first packet-based message from a first software package across a high bandwidth channel (the first packet-based message directed to a first software port), receiving a second packet-based message from a second software package across the high bandwidth channel (the second packet-based message directed to a second software port), selecting the first packet-based message based on the first packet-based message being directed to the first software port, forwarding the first packet-based message across a low bandwidth channel (the bandwidth channel of the high bandwidth channel higher than the bandwidth of the low bandwidth channel), and then forwarding the second packet-based message across the low bandwidth channel.

### BACKGROUND

A growing trend in process control is distributed process control. Rather than having a single, centralized control center sending control commands to remote locations, the control functionality is moved closer to the controlled equipment. The centralized control center takes a more supervisory role in the process control. For example, rather than sending a continuous stream of valve position commands to a valve controlling flow, the centralized control center sends a single flow set point to a remote process controller proximate to the valve. The remote process controller makes valve position adjustments to achieve and maintain the desired flow.

Regardless of the location of the control functionality, the centralized control center may need a stream of data from the remote locations for supervisory purposes. For example, if the remote operation is a hydrocarbon production well, the centralized control center may need to know the instantaneous flow rate of natural gas produced, the BTU content of the natural gas produced, and/or the instantaneous flow rate of oil produced. For these reasons, the centralized control center in distributed process control systems may be referred to as a supervisory control and data acquisition (SCADA) system. FIG. 1 illustrates a related art system in which a SCADA system 10 couples to a remote process controller 12 through a communication channel 14. The communication channel may take many forms, such as an Ethernet network, DSL or ADSL, single wire, radio based, satellite based communication, or a combination of these.

Many of the field or near-field devices used to implement a distributed control system are processor-based devices. Thus, not only do these systems perform their control and/or measurement tasks, but may also be able to perform self diagnostics and keep track of parameters of interest such as serial number of tile device, last calibration date of the device, measurement drift experienced by the device, internal errors that may lead to failure of the device, to name a few. Because of these capabilities, many overall systems also utilize an asset management system 16 to allow the end user to view and in some cases modify asset management parameters. While the asset management parameters are in most cases not critical to the end process being controlled, when systems are implemented such as illustrated in FIG. 1, communications channel 14 traffic regarding asset management data have the same priority as communications to and from the SCADA system 10. Thus, if an excessive number of asset management system-sourced messages are sent, the asset management system messages may limit available bandwidth of the communication channel 14, limiting the ability of the SCADA system 10 to perform its supervisory and data acquisition duties.

### SUMMARY

The problems noted above are solved in large part by a method and related system of message prioritization in a control system. At least some of the illustrative embodiments are methods comprising receiving a first packet-based message from a first software package across a high bandwidth channel (the first packet-based message directed to a first software port), receiving a second packet-based message from a second software package across the high bandwidth channel (the second packet-based message directed to a second software port), selecting the first packet-based message based on the first packet-based message being directed to the first software port, forwarding the first packet-based message across a low bandwidth channel (the bandwidth channel of the high bandwidth channel higher than the bandwidth of the low bandwidth channel), and then forwarding the second packet-based message across the low bandwidth channel.

Yet still other illustrative embodiments are systems comprising a processor, a first communication port coupled to the processor (the first communication port configured to couple to a first communication channel, the first communication channel coupled to one or more selected from the group: an asset management software package; a process control software package; and a data acquisition), and a second communication port coupled to the processor (the second communication port configured to couple to a second communication channel, the bandwidth of the first communication channel higher than the bandwidth of the second communication channel). The processor is configured to receive a high priority message through the first communication port, and to receive low priority message through the first communication port. The processor is also configured to forward the high priority message on the second communication port and then forward the low priority message on the second communication port.

Yet still other illustrative embodiments are systems comprising a first computer system (comprising one or more software packages selected from the group: a data acquisition system software package; and a control system software package), a second computer system (comprising a software package to monitor health and status of field devices remotely located from the second computer system), a first communication channel coupled to each of the first and second computer systems, a plurality of field devices, a second communication channel coupled to the plurality of field devices, and an intermediate device having a high bandwidth communication port and a low bandwidth communication port (the high bandwidth communication port coupled to the first communication channel and the low bandwidth communication port coupled to the second communication channel). The intermediate device is configured to receive a high priority message through the high bandwidth communication port, and to receive a low priority message through the high bandwidth communication port. The processor is also configured to forward the high priority message on the low bandwidth communication port and then forward the low priority message on the low bandwidth communication port.

Yet still other illustrative embodiments are a computer-readable media storing a program that, when executed by a processor, performs a method comprising receiving a first packet-based message from a first software package across a high bandwidth channel (the first packet-based message directed to a first software port), receiving a second packet-based message from a second software package across the high bandwidth channel (the second packet-based message directed to a second software port), selecting the first packet-based message based on the first packet-based message being directed to the first software port, forwarding the first packet-based message across a low bandwidth channel (the bandwidth of the high bandwidth channel higher than the bandwidth of the low bandwidth channel), and then forwarding the second packet-based message across the low bandwidth channel.

The disclosed devices and methods comprise a combination of features and advantages which enable it to overcome the deficiencies of the prior art devices. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 illustrates a related art system;

FIG. 2 illustrates a system constructed in accordance with at least some embodiments of the invention;

FIG. 3 illustrates a field server in accordance with at least some embodiments of the invention;

FIG. 4 illustrates a method that may be implemented by a field server in accordance with at least some embodiments of the invention; and

FIG. 5 illustrates a method that may be implemented by a field server in accordance with at least some embodiments of the invention.

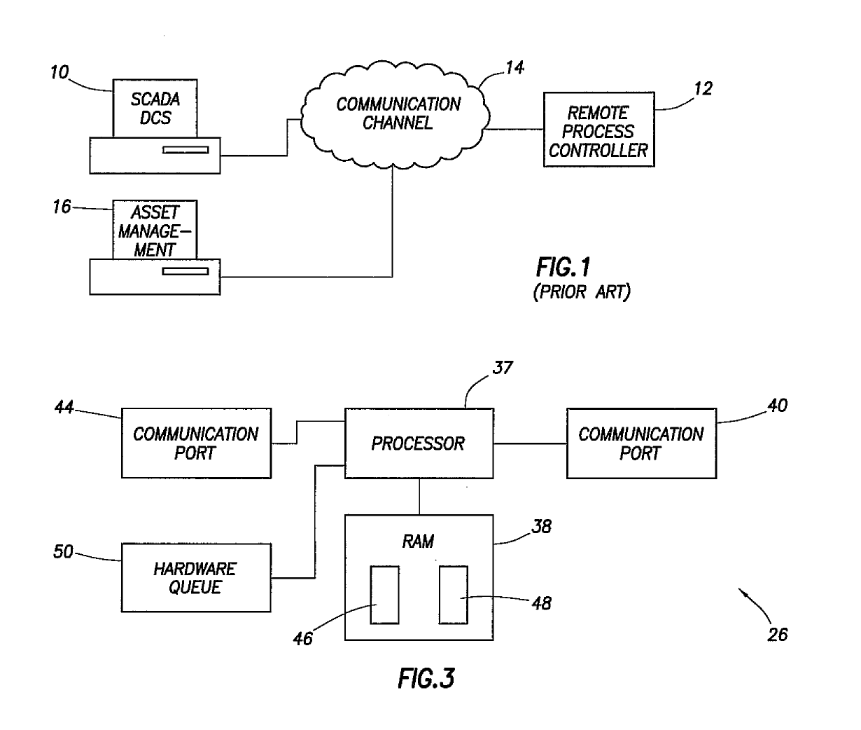

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect electrical connection via other devices and connections.

### DETAILED DESCRIPTION

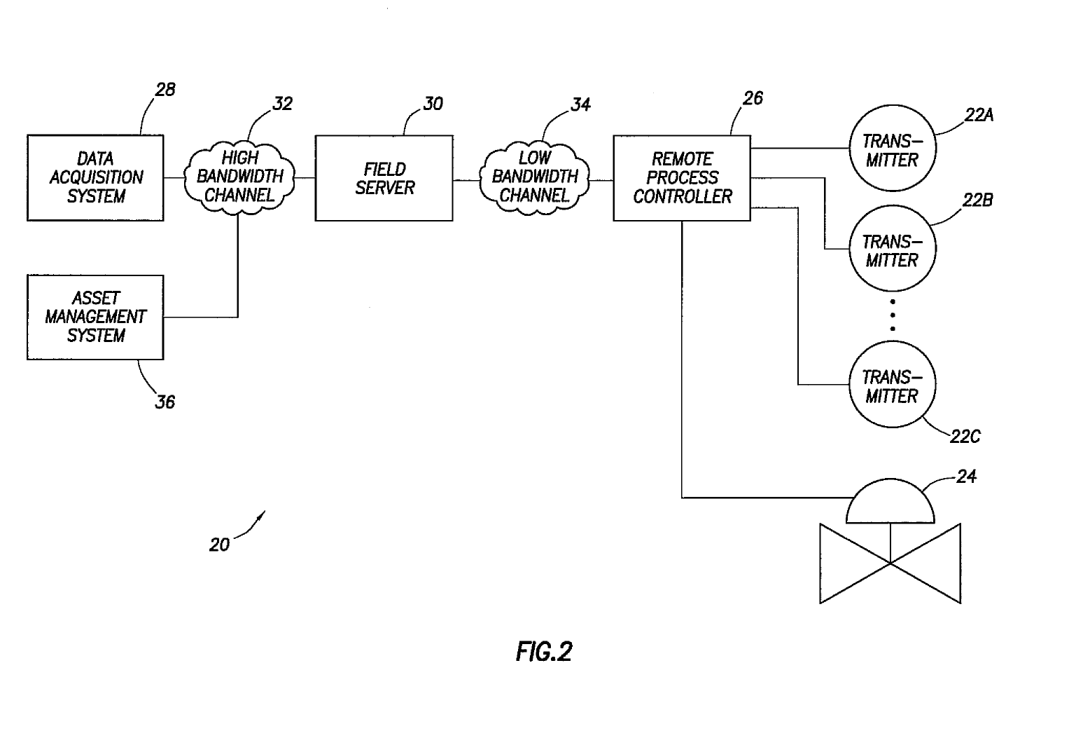

FIG. 2 illustrates a system 20 constructed in accordance with at least some embodiments of the invention. In particular, FIG. 2 shows a plurality of field devices, in this illustrative case being transmitters 22 and control valve 24. The transmitters 22 could be, for example, pressure transmitters, flow transmitters and/or temperature transmitters which measure their respective field parameters and provide that measurement data to the field controller or remote process controller 26. Based at least in part on the data received from the transmitters 22, the remote process controller 26 controls field devices, such as by providing valve position commands to the illustrative control valve 24. A system comprising one or more transmitters 22 and control valve 24 is merely exemplary. Remote process controllers 26 in accordance with embodiments of the invention may couple to any number of field measurement devices and field control devices, and further may be programmed to execute many process control scenarios (e.g., control loops based on measurement data, batch process control). Remote process controller 26 may be, for example, a ROC809 remote operations controller available from Emerson Process Management of St. Louis, Mo.

Still referring to FIG. 2, system 20 further comprises a data acquisition system 28 coupled to the remote process controller 26. The data acquisition system 28 may take many forms (e.g., a data acquisition software package, a processor control software package, and/or a supervisory control and data acquisition (SCADA) software package). These software systems may execute on the same computer system, or on different computer systems. Regardless of the precise form of the data acquisition system 28, these systems obtain measurement data from field devices and remote processor controller 26, and likewise send process control commands to the field devices and/or the remote process controller 26. However, the remote process controller 26, and field devices such as transmitters 22 and control valve 24 may be located tens, hundreds or thousands of miles from the physical location of the data acquisition system 28. To address difficulties of the extended distance, and in accordance with embodiments of the invention, the data acquisition system 28 couples to the remote process controller 26 through a field server 30.

Still referring to FIG. 2, field server 30 couples to the data acquisition system 28 by way of a high bandwidth channel 32. In accordance with some embodiments, the high bandwidth channel 32 is an Ethernet network supporting 10 megabits per second data throughput or greater and implementing TCP/IP as the protocol. In alternative embodiments, the high bandwidth channel may be an Internet connection, a local area network (LAN), a wide area network (WAN), a relatively high bandwidth radio connection, a dedicated telephone network connection (e.g., a T1 connection), and other similar relatively high bandwidth connections. The field server 30 couples to the remote process controller 26 by way of a low bandwidth communication channel 34. Inasmuch as the remote process controller 26 may be located proximate to the field operations and may be many miles from the physical location of the field server 30, the low bandwidth connection may be any available communication channel to inexpensively span the distance between the field server 30 and the remote process controller 26, such as a dial-up or leased phone line connection, cellular phone, GSM or GPRS, radio, a satellite communication system, or a combination of these. The low bandwidth communication channel 34 may have a data throughput of 256 kilo-bits per second or less in some embodiments.

Still referring to FIG. 2, the field devices, such as transmitters 22, measure field parameters and create measurement data that is provided to the remote process controller 26. In accordance with at least some embodiments of the invention, the exemplary transmitters 22 couple to the remote process controller 26 by way of 4-to-20 mA current loops, wherein the electrical current drawn by each transmitter 22 is directly proportional to the measured field parameter. In accordance with alternative embodiments of the invention, the transmitters 22 may be highway addressable remote transducer (HART®) compatible, and thus in addition to or in place of a value indicated by the 4-to-20 mA signal, the transmitters may digitally communicate their measurement data to the remote process controller over the electrical wires carrying the 4-to-20 mA current loop. Use of a 4-to-20 mA current loop or HART digital communications over a 4-to-20 mA current loop are merely exemplary of the communication protocols that may be used between the remote process controller 26 and field devices such as transmitters 22. Any currently existing, or after developed, communication protocol may be used in the communications between the remote processor controller 26 and the field devices, such as Foundation FieldBus and/or the MODBUS protocols.

Still referring to FIG. 2, a process control system 20 may also have an asset management system 36. An asset management system may be a computer system implementing a software package that gathers and maintains status and configuration data regarding a process control system, including status and configuration data from field devices such as transmitters 22. Status data may comprise information such as transmitter health, internal diagnostics, input voltage, current input, current output, communications health, and configuration changes. Configuration data may comprise information such as serial numbers, calibration dates, calibration parameters tuning parameters, generic text messages, instrument materials constructions, instrument sensor ranges, instrument input signal ranges, instrument output signal ranges, and alarm setpoints. This information may be helpful in troubleshooting failures of a process control system and/or implementing preventative maintenance programs. In some embodiments, the asset management system 36 may comprise the AMS™ Suite series of products available from Emerson Process Management.

In order to gather the status and configuration data, the asset management system 36 couples to the field devices through the field server 30 and remote process controller 26. In some embodiments, the asset management system 36 communicates directly with field devices to request and receive information. In these embodiments, field server 30 and the remote process controller 26 act as message routers directing the request to the appropriate field device, and likewise returning the requested information from the field device back to the asset management system. Consider, for purposes of explanation only, that the asset management system desires to obtain status and/or configuration data regarding transmitter 22A. In such a circumstance, the asset management system may generate a message that is sent to the field server. The data caching system 30, recognizing the request as originating from an asset management system and not the data acquisition system 28, forwards the request to the appropriate remote process controller 26 (keeping in mind that each field server 30 may couple to multiple remote process controllers and therefore multiple field devices). The remote process controller 26, receiving the forwarded request, examines the message and in turn forward the request to the appropriate field device, in the exemplary case transmitter 22A. Transmitter 22A, upon receiving the request, provides the requested information by originating a message whose ultimate destination is the asset management system 60. However, because the transmitter 22A couples to the remote process controller 26, the message is initially sent to the remote process controller 26. Recognizing that the message is destined for upstream devices, the remote process controller 26 forwards the message across the low bandwidth communication channel 34 to the data caching system 30. Likewise, the data caching system, recognizing that the message is not measurement data, forwards the response to the asset management system 36.

FIG. 3 shows an electrical block diagram of a field server 30 in accordance with embodiments of the invention. In particular, the field server may comprise a processor 37 coupled to random access memory (RAM) 38. The processor 37 may take many forms. In some embodiments, the processor may be a microcontroller, and thus the RAM 38 functionality, along with other components such as read only memory (MOM) and communications capabilities, are integrated on a single semiconductor die. In alternative embodiments, the processor 37 is a standalone processor (e.g., a processor manufactured by Intel®: Freescale/Motorola and/or AMD), and thus may be coupled to other individual components, such as the RAM 38. Moreover, processor 37 may be an application specific integrated circuit (ASIC), a field programmable gate array (FPGA), and/or system on a chip. Regardless of the precise nature of the processor 37, the processor may be programmed to perform desired functions such as implementing a communication priority system in accordance with the embodiments of the invention.

The processor 37 may couple to and communicate with the remote process controllers 26 by way of a communication port 40. The precise nature of the communication port 40 depends on the type of connection to the remote process controller 26. For example, if the field server 30 communicates to the remote process controller 26 by way of a dedicated serial communication pathway, the communication port 40 may be a universal asynchronous receiver transmitter (UART) device. In alternative embodiments where the low bandwidth communication channel 34 is a cellular phone connection, the communication port 40 may be a device capable of interfacing with cellular telephone equipment. Likewise, if the low bandwidth communication channel 34 is a radio or satellite communication channel, then the communication port 40 may be a system capable of interfacing with a radio control or satellite control respectively.

Still referring to FIG. 3, the remote process controller 26 may further comprise yet another communication port 44 coupled to the processor 37. Communication port 44 allows the processor 37 to communicate with upstream devices, such as the data acquisition system 28 and asset management system 36 (of FIG. 2). In some embodiments, the communication port 44 may be a device configured to communicate by way of an Ethernet network, whether coupled directly to the data acquisition system, or through one or more local area networks, wide area networks and/or other devices such as routers.

In order to ensure that the high priority messages originating from the data acquisition system are acted upon before the low priority messages originating from the asset managing system 36, in accordance with at least some embodiments of the invention the field server 30 implements a queue structure. In some embodiments, the queues are implemented in the RAM 38, such as queues 46 and 48. In alternative embodiments, the queues may be implemented in hardware, such as hardware queue 50. The remaining discussion is directed only to the software queues 46 and 48; however, queues implemented in the hardware queue 50 operate similarly.

Still referring to FIG. 3, in accordance with the embodiments of the invention at least two queues are used. These queues may be designated as the high priority queue 46 and low priority queue 48. Packet-based messages originating at the data acquisition system 28 (FIG. 2) are received by the communication port 44 and placed in the high priority queue 46. Likewise, packet-based messages originating at the asset management system 36 (FIG. 2) are received by the communication port 44 and placed in the low priority queue 48. The mechanism by which the processor 37 differentiates between high priority messages and low priority messages may take many forms. In some embodiments, the packet-based messages originating from the data acquisition system 28 are sent to a particular TCP/IP software port address of the field server 30. Likewise, packet-based messages originating from the asset measurement system 36, while arriving at the same communication port 44 of the field server 30, are sent to a different TCP/IP software port address. Thus, in these embodiments the processor 37 differentiates high priority messages from low priority messages based on the software port address to which the message is directed. In alternative embodiments of the invention, the processor 37 analyzes the contents of the message to determine the source of the message. Other methods for differentiating between high priority messages and low priority messages may be equivalently used.

Still referring to FIG. 3, simultaneously with receiving various packet-based messages across the communication port 44 and placing those messages selectively in the high priority queue 46 or the low priority queue 48, the processor 37 is also configured to extract messages from the queues 46 and 48 and the messages to the remote processor controller 26 and/or the field devices by way of communication port 40. In particular, each of the high priority queue and the low priority queue are first in-first out (FIFO) queues. Because the bandwidth of the low bandwidth communication channel 34 may be lower than the high bandwidth communication channel 32, the rate of which packet-based messages are received by the field server 30 may be greater than the rate at which the messages may be encapsulated in an appropriate protocol and sent across low bandwidth communication channel 34. In some embodiments, the protocol used on the low bandwidth channel is the ROC protocol, a proprietary protocol of Emerson Process Management; however, any protocol suitable for use on the low bandwidth channel may be equivalently used. The queues 46 and 48 act as a buffer for these communications.

In accordance with the embodiments of the invention, the processor 37 is configured to operate exclusively on the packet-based messages is the high priority queue when any such messages are present. When all the packet-based messages in the high priority queue have been serviced and the queue 46 is empty, then the processor 37 is configured to begin operations on the just packet-based message in the low priority queue 48. In some embodiments, the messages embodied by the packet-based messages are request/response type messages. That is, for the transaction to complete the field server 30 forwards the message to downstream devices, and waits for a reply. When the reply is received, that reply is then forwarded to the originating device. Thus, in accordance with at least some embodiments, even if a high priority message arrives in the high priority queue 46 while the processor 37 is servicing a message in the low priority queue 48, the request/reply response is completed for the low priority message before the processor 37 begins the operation with respect to the newly arrived message in the high priority queue 46.

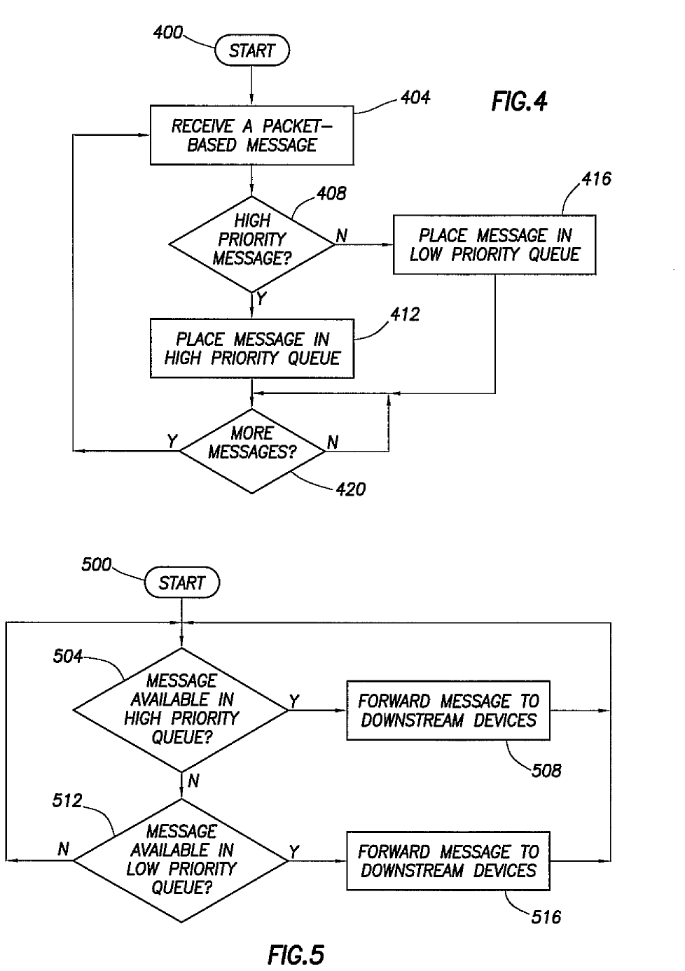

FIG. 4 illustrates a method in accordance with the embodiments of the invention. The method may be implemented, for example, in a field server 30 (FIG. 2). The illustrative method starts (block 400) and moves to receiving a packet-based message (block 404). Receipt of packet-based message may be across the communication port 44 (FIG. 3), and the message originates from the data acquisition system 28 and/or the asset management system 36 FIG. 2). After the message is fully or partially received, a determination is made as to whether the message is high priority message (block 408). As discussed above, and in some embodiments, this determination is made by ascertaining the software port address to which the message was directed. In alternative embodiments, the priority may be determined by ascertaining the source of the message by inspecting various portions of the packet-based message itself. Regardless of the precise method by which the determination is made, if the message is a high priority message, the message is placed in the high priority queue (block 412), such as high priority queue 46 (FIG. 3). If, on the other hand, the message is a low priority message (block 408), the message is placed in the low priority queue (block 416), such as low priority queue 48 (FIG. 3). Regardless of where the message is placed, a determination is made as to whether there are more incoming messages (block 420). If not the illustrative method spins in a software loop (block 420) until such time as a new message begins to arrive. When a new message begins to arrive, the illustrative method retreats to receiving the packet-based message (block 404) and the process repeats.

FIG. 5 illustrates a further method in accordance with the embodiments of the invention. The illustrative methods of FIG. 4 and FIG. 5 in some embodiments run substantially simultaneously in the field server 30. In other embodiments, the illustrative methods of FIGS. 4 and 5 may be combined into a single method implemented in the field server 30. Regardless of the precise nature of how the illustrative method of FIG. 5 is implemented, the illustrative method starts (block 500) and moves to a determination of whether there is a message available in the high priority queue (block 504). This determination is made by scanning the high priority queue 46 (FIG. 2) for available messages. If there is a high message available in the high priority queue, then the message is forwarded to downstream devices (block 508), and method retreats again to a determination of whether there is a message in the high priority queue (block 504). Thus, as long as there are messages available in the high priority queue, the field server 30 forwards those messages to the downstream devices without regard to whether there are messages in the low priority queue.

Still referring to FIG. 5, in the event that the high priority queue does not contain any messages (block 504), then the illustrative method moves to a determination of whether there is a message available in the low priority queue (block 512). If there is a message available, the field server 30 forwards that message to down stream devices (block 516). As between the high priority message and the low priority messages, each of these message may be directed to the same field device or different field devices. If, on the other hand, there is not a low priority message available in the low priority queue (block 512), then the illustrative method retreats to again examining the high priority queue (block 504).

From the description provided herein, those skilled in the art are readily able to combine software created as described with appropriate general purpose or special purpose computer hardware to create a computer system and/or computer subcomponents embodying the invention, to create a computer system and/or computer subcomponents for carrying out the method of the invention, and/or to create computer-readable media for storing a software program to implement the method aspects of the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
receiving a first packet-based message from a first software package across a high bandwidth channel, the first packet-based message directed to a first software port;
receiving a second packet-based message from a second software package across the high bandwidth channel, the second packet-based message directed to a second software port;
selecting the first packet-based message based on the first packet-based message being directed to the first software port;
forwarding the first packet-based message across a low bandwidth channel, the bandwidth of the high bandwidth channel higher than the bandwidth of the low bandwidth channel; and then forwarding the second packet-based message across the low bandwidth channel.

2. The method as defined in claim 1 wherein receiving the first packet-based message further comprises receiving the first packet-based message originating from at least one selected from the group: a data acquisition system software package; or control system software package.

3. The method as defined in claim 1 wherein receiving the second packet-based message further comprises receiving the second packet-based message originating from an asset management software package.

4. The method as defined in claim 1 wherein receiving further comprises:
receiving the first packet-based message;
placing the first packet-based message in a first queue based on the software port to which the first packet-based message was directed;
receiving the second packet-based message; and
placing the second packet-based message in a second queue based on the software port to which the second packet-based message was directed.

5. The method as defined in claim 4 wherein selecting further comprises:
selecting a packet-based message from the first queue if a packet-based message is available in the first queue; and
selecting a packet-based message from the second queue only if there is not a packet-based message available in the first queue.

6. The method as defined in claim 4 where placing further comprises:
placing the first packet-based message in a first software queue; and
placing the second packet-based message in a second software queue.

7. The method as defined in claim 1 further comprising:
wherein forwarding the first packet-based message further comprises forwarding to a first device coupled to the low bandwidth channel; and
wherein forwarding the second packet-based message further comprises forwarding to a second device coupled to the low bandwidth channel.

8. The method as defined in claim 1 further comprising:
wherein forwarding the first packet-based message further comprises forwarding to a first device coupled to the low bandwidth channel; and
wherein forwarding the second packet-based message further comprises forwarding to the first device.

9. A system comprising:
a processor;
a first communication port coupled to the processor, the first communication port configured to couple to a first communication channel, the first communication channel coupled to one or more selected from the group: an asset management software package; a process control software package; and a data acquisition software package;
a second communication port coupled to the processor, the second communication port configured to couple to a second communication channel, the bandwidth of the first communication channel higher than the bandwidth of the second communication channel;
wherein the processor is configured to receive a high priority message through the first communication port, and to receive low priority message through the first communication port; and
wherein the processor is configured to forward the high priority message on the second communication port and then forward the low priority message on the second communication port.

10. The system as defined in claim 9 wherein the high priority message comes from either the process control software package or the data acquisition software package; and wherein the low priority message comes from the asset management software package.

11. The system as defined in claim 9 wherein the processor is configured to put high priority messages in a first queue and low priority messages in a second queue, and wherein the processor is configured to forward all the messages from the first queue before forwarding messages from the second queue.

12. The system as defined in claim 11 wherein the processor is configured to place the high priority messages in the first queue being a hardware queue, and to place the low priority messages in a second queue being a hardware queue.

13. The system as defined in claim 9 wherein the processor is configured to forward the high priority message out the second communication port to a first device and wherein the processor is configured forward the low priority message out the second communication port to the first device.

14. The system as defined in claim 9 wherein the processor differentiates high priority messages and low priority messages based on a software port address used by the sending device.

15. A system comprising:
a first computer system comprising one or more software packages selected from the group: a data acquisition system software package; and a control system software package;
a second computer system comprising a software package to monitor health and status of field devices remotely located from the second computer system;
a first communication channel coupled to each of the first and second computer systems;
a plurality of field devices;
a second communication channel coupled to the plurality of field device; and
an intermediate device having a high bandwidth communication port and a low bandwidth communication port, the high bandwidth communication port coupled to the first communication channel and the low bandwidth communication port coupled to the second communication channel;
wherein the intermediate device is configured to receive a high priority message through the high bandwidth communication port, and to receive a low priority message through the high bandwidth communication port; and
wherein the processor is configured to forward the high priority message on the low bandwidth communication port and then forward the low priority message on the low bandwidth communication port.

16. The system as defined in claim 15 wherein the high priority message comes from a software package on the first computer system,

17. The system as defined in claim 16 wherein the low priority message comes from the second computer system.

18. The system as defined in claim 15 wherein the intermediate device is configured to forward the high priority message out the low bandwidth communication port to a first device of the plurality of devices, and wherein the intermediate device is configured forward the low priority message out the low bandwidth communication port to the first device.

19. The system as defined in claim 15 wherein the first computer system directs messages to a first software port address of the intermediate device, wherein the second computer system directs messages to a second software port address of the intermediate device, and where the intermediate device differentiates high priority messages and low priority messages based on a software port address.

20. The system as defined in claim 15 wherein the intermediate device is configured to put high priority messages in a first queue and low priority messages in a second queue, and wherein the intermediate device is configured to forward all the messages from the first queue before forwarding messages from the second queue.

21. The system as defined in claim 20 wherein the intermediate device is configured to place the high priority messages in the first queue being a hardware queue, and to place the low priority messages in a second queue being a hardware queue.

22. A computer-readable media storing a program that, when executed by a processor, performs method comprising:
receiving a first packet-based message from a first software package across a high bandwidth channel, the first packet-based message directed to a first software port;
receiving a second packet-based message from a second software package across the high bandwidth channel, the second packet-based message directed to a second software port;
selecting the first packet-based message based on the first packet-based message being directed to the first software port;
forwarding the first packet-based message across a low bandwidth channel, the bandwidth of the high bandwidth channel higher than the bandwidth of the low bandwidth channel; and then
forwarding the second packet-based message across the low bandwidth channel.

23. The computer-readable media as defined in claim 22 wherein the receiving further comprises:
receiving the first packet-based message;
placing the first packet-based message in a first queue based on the software port to which the first packet-based message was directed;
receiving the second packet-based message; and
placing the second packet-based message in a second queue based on the software port to which the second packet-based message was directed.

24. The computer-readable media as defined in claim 23 wherein selecting further comprises:
selecting a packet-based message from the first queue if a packet-based message is available in the first queue; and
selecting a packet-based message from the second queue only if there is not a packet-based message available in the first queue.

25. The computer-readable media as defined in claim 22 wherein the method further comprises:
wherein forwarding the first packet-based message further comprises forwarding to a first field device coupled to the low bandwidth channel; and
wherein forwarding the second packet-based message further comprises forwarding to a second field device coupled to the low bandwidth channel.

26. The computer-readable media as defined in claim 22 wherein the method further comprises:
wherein forwarding the first packet-based message further comprises forwarding to a first field device coupled to the low bandwidth channel; and
wherein forwarding the second packet-based message further comprises forwarding to the first field device.
